(19) United States
(12) Patent Application Publication
(10) Pub. No.: US 2009/0277034 A1
(43) Pub. Date: Nov. 12, 2009

(54) CLOTHES DRYER AIR INTAKE SYSTEM

(76) Inventor: Clive A. Wilson, Mooresville, NC (US)

Correspondence Address: ADAMS INTELLECTUAL PROPERTY LAW, P.A., Suite 2350 Charlotte Plaza, 201 South College Street, CHARLOTTE, NC, 28244, US

(21) Appl. No.: 12/434,033

(22) Filed: May 1, 2009

Related U.S. Application Data
(60) Provisional application No. 61/051,106, filed on May 7, 2008.

(51) Int. Cl. F26B 21/00; F26B 25/08; D06F 58/04

(52) U.S. Cl. 34/82; 34/232; 34/235; 34/132

(57) ABSTRACT

An air intake system for supplying outdoor air to a clothes dryer, the system including an enclosure positioned to substantially cover an air intake of a clothes dryer and a conduit coupling the enclosure with the outdoor environment, the enclosure defining an air space for maintaining a volume of supply air and an open side positioned adjacent the air intake such that air is supplied to the air intake from the supply air.

### CROSS-REFERENCE TO RELATED APPLICATION

This application claims priority to U.S. provisional application Ser. No. 61/051,106 filed May 7, 2008 and entitled “CLOTHES DRYER AIR INTAKE SYSTEM,” the contents of which are incorporated herein by reference.

### TECHNICAL FIELD AND BACKGROUND OF THE INVENTION

1. Field of the Invention

The present invention relates generally to the field of clothes dryers, and more particularly, to dryer inlet systems for providing intake air to a dryer from an external location, such as the ambient air outside of a house.

2. Background of the Invention

Conventional clothes dryers typically function by circulating air in order to remove moisture from a load of tumbling clothing. Specifically, dryers function by continuously withdrawing a volume of air from the environment in which the dryer is positioned, passing the air through a heating element operable for heating the air to a predetermined temperature, passing the heated air through a rotating drum to capture evaporated moisture, and exhausting the moist air to the outside environment through an exhaust vent. Exhaust air is preferably discharged away from the inlet of the dryer in order to avoid increasing the moisture content of the supply air, which would decrease the efficiency of the system. Moist air is also preferably discharged outside the house to avoid mold and mildew issues.

Referring to FIGS. 1 and 2, prior art clothes dryer systems are shown. Referring specifically to prior art FIG. 1, a conventional dryer 4 is shown positioned within a structure 2, such as a house, defining internal and external environments. The clothes dryer 4 includes an exhaust hose 6 extending between an exhaust vent of the dryer and the outside environment 8. In this manner, outlet air having a high-moisture content is discharged to the exterior of the house. Referring specifically to prior art FIG. 2, a rear perspective view of the dryer shown in FIG. 1 details the inlets and exhaust. As shown, the dryer 4 includes an exhaust hose 6 coupled with an exhaust vent, wherein the exhaust hose 6 has a length sufficient to connect with an outlet to the outside environment. Although not shown, the exhaust vent is operable for moving air out of the rotating drum of the dryer 4. The back panel of the dryer 4 includes a plurality of vents 10 through which supply air is withdrawn into an intake positioned beneath the vents and proximate the heating element. Although the dryer 4 is an “open” system in that it is not sealed and air can be withdrawn through all openings of the dryer, a significant portion of the supply air enters through the vents 10.

It is estimated that air is withdrawn at a rate of about 200 cubic feet/minute by a standard, conventional clothes dryer. Since the air supplying the dryer is taken from within the house, the supply air is typically conditioned air (i.e., heated or cooled). Conditioned air requires energy and cost to produce, and the negative pressure created in the house by withdrawing air causes outside air to be pulled into the house through doors, windows, garages, attics and basements, which must then also be conditioned at a cost. Conditioning includes not only heating and cooling, but also removing dust and allergens, leading to more frequent filter replacement. While various systems have been developed to recapture dryer exhaust heat to conserve energy, there exists a need in the art for systems for conserving energy in the supply process of dryer operation.

Accordingly, what is desired is an air intake system for a conventional dryer that eliminates or substantially reduces the withdrawal of interior conditioned air. Further, what is desired is an air intake system that not only reduces the energy consumption of a dryer, but also provides other advantageous features for improving the air quality inside of a house. A desirable air intake system would be capable of being installed as original equipment or as a retrofit item.

### BRIEF SUMMARY OF THE INVENTION

Therefore, it is an object of the invention to provide an external air intake system for a clothes dryer.

It is another object of the invention to provide an external air intake system for a clothes dryer including air filtering means.

It is yet another object of the invention to provide a clothes dryer with an external air intake system that improves the efficiency of the dryer and reduces the impact of the dryer on the resource budget of a house.

It is yet another object of the invention to provide an air intake system for supplying external intake air to a plurality of interconnected clothes dryers.

These and other objects of the present invention are achieved in the embodiments disclosed below. According to one embodiment, the present invention provides an air intake system including a housing coupled to the dryer for directing outside air to the general area of the air intake of the dryer. The housing is coupled to an air supply conduit that is fed with air from the outside environment. The system may further include a filtration system positioned at any point along the length of the system prior to the intake for filtering at least one of dust, pollen, dander, moisture or other particles from the supply air.

According to another embodiment, the present invention provides an air intake system including a conduit for interconnecting an intake of the dryer with the outside environment, through which outside air is supplied to the dryer. The system may further include a filtration system positioned at any point along the length of the system.

According to another embodiment, the present invention provides a clothes dryer intake system for supplying outside air to a plurality of clothes dryers, wherein each of the plurality of clothes dryers includes an intake vent through which the air is received and passed to a heating element. The system includes a conduit for supplying outside air to the plurality of intakes simultaneously or as needed.

According to another embodiment, the air intake system includes a baffle or other means for selectively limiting or stopping the flow of air through the conduit between uses.

According to another embodiment, the supply air is conditioned or unconditioned.

According to another embodiment, the system further includes a filter.

According to another embodiment, the system further includes a filter positioned between the outside environment and the air intake.

According to another embodiment, the system further includes a filter positioned at the interface with the external environment.

According to another embodiment, the system further includes a baffle positioned between the external air supply and the intake housing.

According to another embodiment, the system further includes a humidity control system.

According to another embodiment, a clothes dryer intake system includes a clothes dryer having an intake system for providing intake air to a heating element of a clothes dryer. An inlet connection coupled with an opening of the intake system provides intake air to the heating element. An intake hose supplies intake air into the inlet connection and has a first end connected to the inlet connection and second end connected with the external air supply.

### BRIEF DESCRIPTION OF THE DRAWINGS

Some of the objects of the invention have been set forth above. Other objects and advantages of the invention will appear as the description of the invention proceeds when taken in conjunction with the following drawings, in which:

FIG. 1 is a schematic diagram of a prior art clothes dryer positioned within a house;

FIG. 2 is a rear perspective view of a prior art clothes dryer;

FIG. 3 is a rear perspective view of a clothes dryer including an air intake system according to an embodiment of the invention;

FIG. 4 is a detailed view of the air intake system shown removed from the dryer;

FIG. 5 is a schematic diagram of an air intake system shown installed in a house;

FIG. 6 is a rear perspective view of a clothes dryer including an air intake system including a baffle/filter assembly;

FIG. 7 is a rear perspective view of a clothes dryer including an air intake system filter assembly;

FIG. 8 is a detailed perspective view of an alternative embodiment of a clothes dryer air intake system; and

FIG. 9 is a schematic diagram illustrating a dryer network including a shared external air source intake.

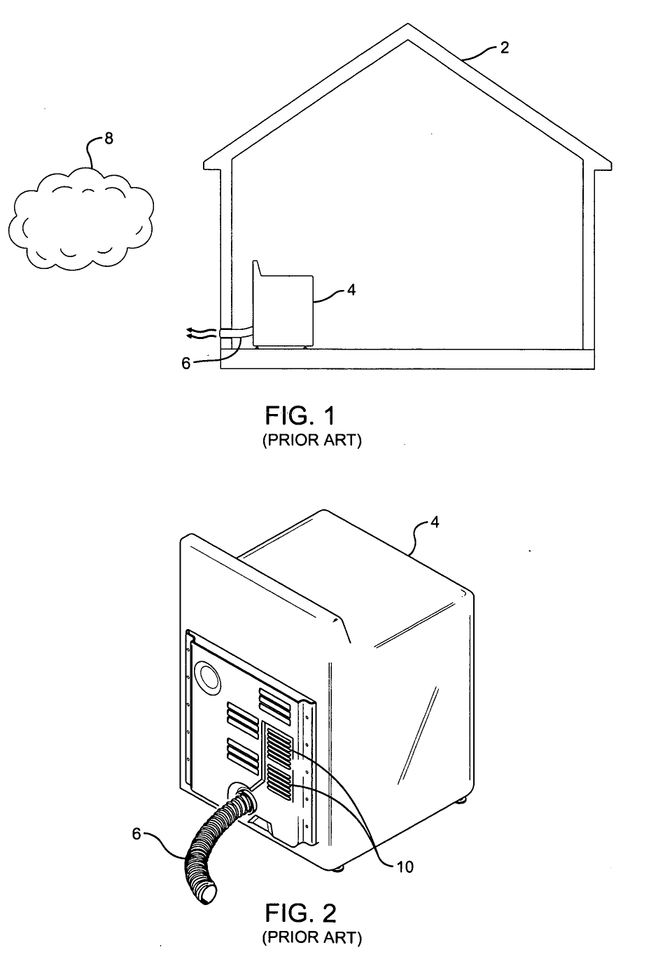

### DETAILED DESCRIPTION OF THE INVENTION

The present invention will now be described more fully hereinafter with reference to the accompanying drawings in which exemplary embodiments of the invention are shown. However, the invention may be embodied in many different forms and should not be construed as limited to the representative embodiments set forth herein. The exemplary embodiments are provided so that this disclosure will be both thorough and complete, and will fully convey the scope of the invention and enable one of ordinary skill in the art to make, use and practice the invention. Like reference numbers refer to like elements throughout the various drawings.

Referring now to the drawings, various embodiments of external air source intake systems for clothes dryers are provided. The systems provided herein may be readily modified by those skilled in the art to accommodate any conventional dryer design including an air intake. It is envisioned that the systems of the present invention may be sold as a kit of parts or installed as original equipment. As used throughout the specification, the term “outdoor air” is intended to include the air source external to the structure in which a dryer associated with the invention is positioned, thus, un-conditioned air unaffected by the structure or HVAC systems associated with the structure.

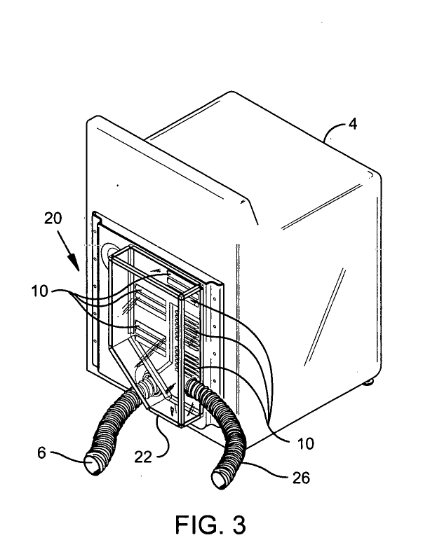

Referring to FIG. 3, a first embodiment of an air intake system for clothes dryers is shown generally at 20. The system 20 is shown fitted to a conventional dryer 4, such as in a retrofit application. In an alternative embodiment, the system 20 may be installed as original equipment. The system 20 is shown installed and covering all or a substantial portion of the plurality of vents 10 located on the back of the dryer 4 through which the air supply enters to the intake and heating element. A function of the enclosure 22 is to substantially seal off the air intake of the dryer from the air supply in which the dryer is positioned, requiring the dryer to withdraw air from the outside environment through a conduit and the enclosure 22. The system 20 is independent from and preferably positioned away from the dryer exhaust to prevent exhaust air with a high-moisture content from entering into the supply air intake.

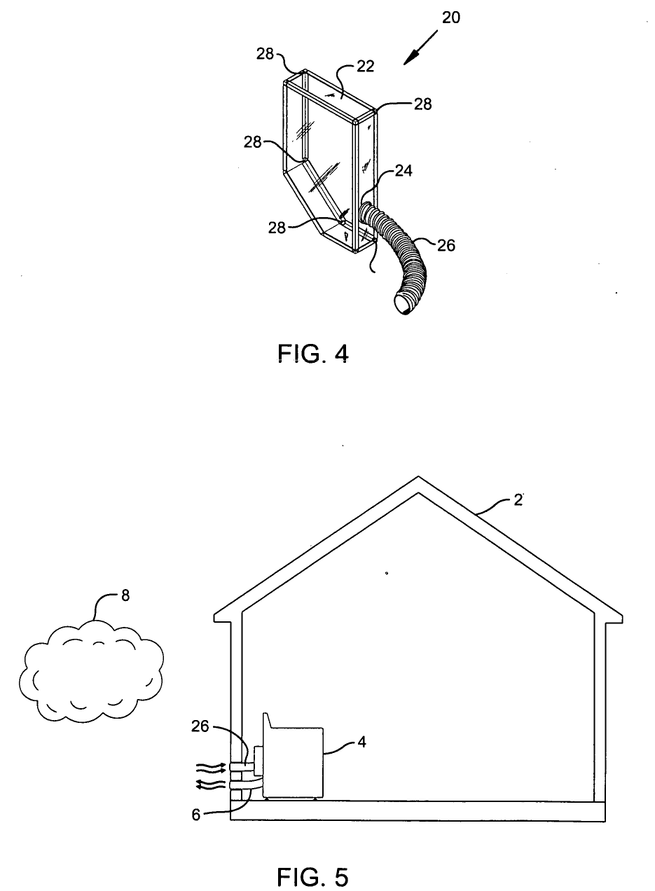

Referring to FIGS. 3 and 4, the air intake system 20 includes an intake enclosure 22, also referred to herein as a “housing,” defining an air space therein and substantially covering all or a portion of the plurality of intake vents 10. In one embodiment, a portion of the vents 10 are covered to achieve a direct supply of outside air to the dryer. An intake enclosure installed over a portion of the vents on the outside of the bulkhead adjacent to the internal dryer air intake port may be sufficient to supply outside air. The enclosure 22 may have any size or shape that preferably corresponds to the arrangement of underlying intake vents 10. The enclosure 22 is open on the side adjacent the intake vents 10, and defines an air space for maintaining a volume of air therein for supplying the dryer with supply air. The enclosure 22 defines a port 24 for coupling a conduit 26 to the enclosure 22. The conduit 26 defines first and second opposed ends extending from the enclosure 22 to the outside environment, respectively, in order to draw outside air. The conduit 26 is preferably flexible to facilitate routing between the intake and the opening to the outside, and may have any length suitable to bridge the distance between the dryer 4 and an outside.

As shown, the enclosure 22 is an open-box structure including a plurality of sides and is preferably made from a hardened material to maintain its shape and prevent collapse of the air space. Suitable enclosure materials include, but are not limited to, metals and hardened plastics. The enclosure 22 may be made from one or more pieces and the conduit 26 may be a separate attached component or may be integral with the enclosure. The enclosure 22 may have any shape to accommodate varying dryer designs and vent arrangements. The enclosure 22 may be removably fastened to the dryer by way of any suitable fastener 28 including, but not limited to, magnets, screws or hook-and-loop fasteners. The system may further include a seal positioned between the metal back of the dryer and the enclosure 22. The enclosure may further be provided with a flap or like feature that is selectively opened and closed to choose between an indoor and outdoor air supply as desired. The flap may be manually controlled by any conventional mechanical means, or may be automatically controlled through the control panel of the dryer.

Referring to FIG. 5, a dryer 4 including the air intake system 20 of the present invention is shown positioned within a house 2. With respect to their position on the house structure, the exhaust vent 6 and intake conduit 26 are preferably positioned apart to prevent cross-contamination of moist air. Thus, it is undesirable for the moist air expelled to the outside environment 8 to be withdrawn by the supply side. In an alternative embodiment, the exhaust vent 6 and intake conduit 26 may be interconnected through a conventional heat recapture system that includes a means for removing moisture, thus creating a heat recycling system.

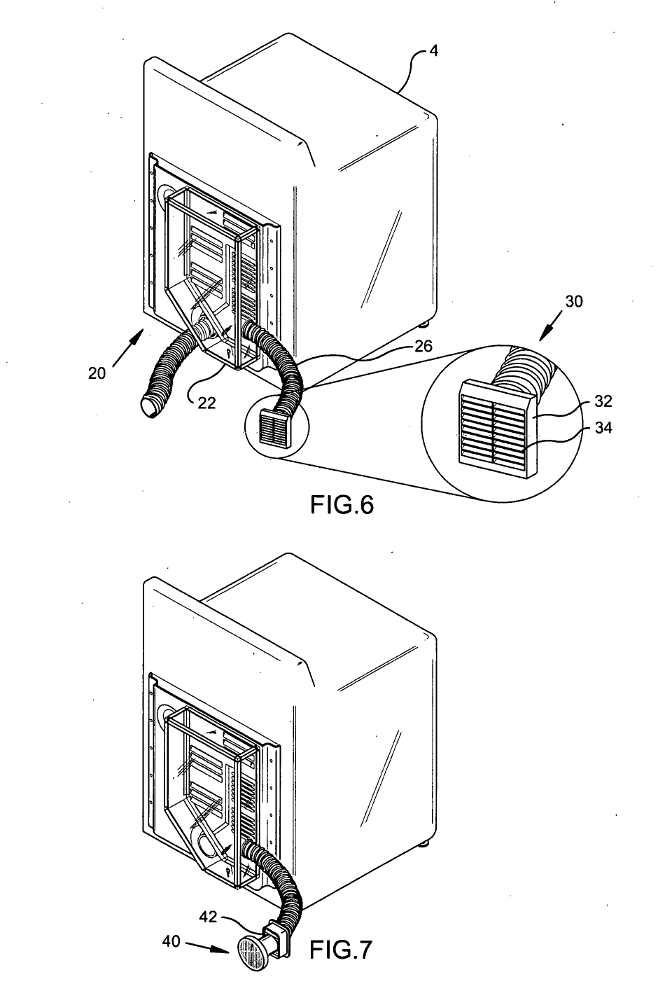

Referring to FIG. 6, the air intake system 20 may further include a baffle apparatus 30 for blocking/controlling the flow of air from the outside environment. As shown, the baffle apparatus 30 is positioned about the end of the conduit 26 adjacent the outside environment. In alternative embodiments, the baffle apparatus 30 may be positioned at any point along the length of the conduit 26, or may be positioned within the enclosure 22. As shown, the baffle apparatus 30 includes a fixture 32 mounted within the wall of the house. One or more flaps, fins or vents may be selectively opened and closed upon operation of the dryer and need for supply air. The baffle may be controlled (i.e., opened) by suction created from the dryer or may be controlled by a mechanical lever or by the operation of the control panel of the dryer. The baffle preferably remains closed between periods of use to prevent contaminants and pests from entering the conduit 26 and blocking or contaminating the air supply. It is envisioned that various designs are suitable for functioning as a baffle as are known to those skilled in the art, such as a selector valve, and the baffle is not intended to be limited to the design shown.

Referring to FIG. 7, the air intake system 20 may further include a filter system 40 including at least one filter 42 for filtering moisture, particulates, contaminants, dander, pollen or any other material. The filter system 40 may be positioned at any point along the system, such as at the interface with the external environment or the interface with the dryer air intake. The filter is preferably positioned at a readily accessible position for regularly scheduled maintenance. In one embodiment, the filter includes a moisture reducing apparatus that may include a drain to the outside environment for discarding water. In situations in which the air supply has a high-moisture content, it may be necessary to reduce the moisture content of the supply air to increase the efficiency of the dryer. In an alternative embodiment, the moisture content of the supply air may be reduced by increasing the temperature of the heating element or exposure time of the supply air to the heating element. The filter system 40 and baffle apparatus 30 may be combined into a single unit, or one system/apparatus may perform both functions.

The size of the intake may be reduced when incorporating a blower motor to assist with supplying air to the dryer. In a further embodiment, the filter system 40 includes a filter box positioned adjacent the inside wall, a selector valve for indoor or outdoor air sourcing adjacent the filter box, a blower motor adjacent the selector valve and a conduit running from the blower motor to the vicinity of the dryer internal intake port. In other embodiments, the blower motor may be positioned anywhere between the dryer intake port and the outdoor air source. The incorporation of the blower motor may in some embodiments obviate the need for the enclosure 22, so long as the end of the conduit adjacent the dryer intake port is positioned in close proximity to the intake port.

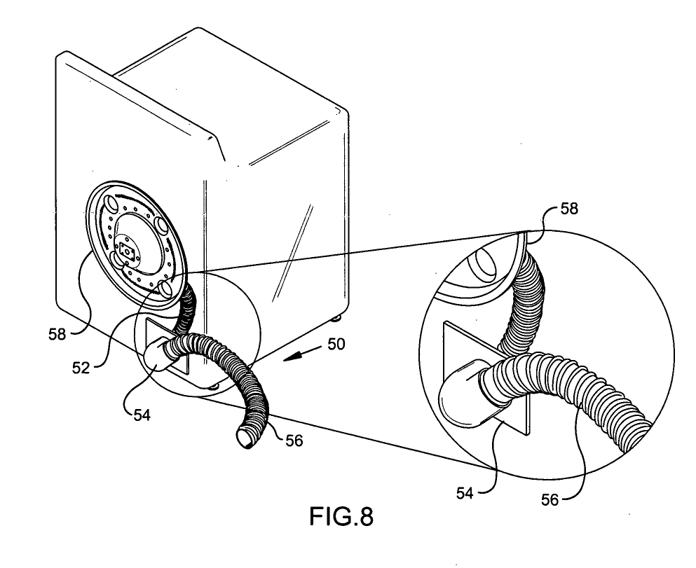

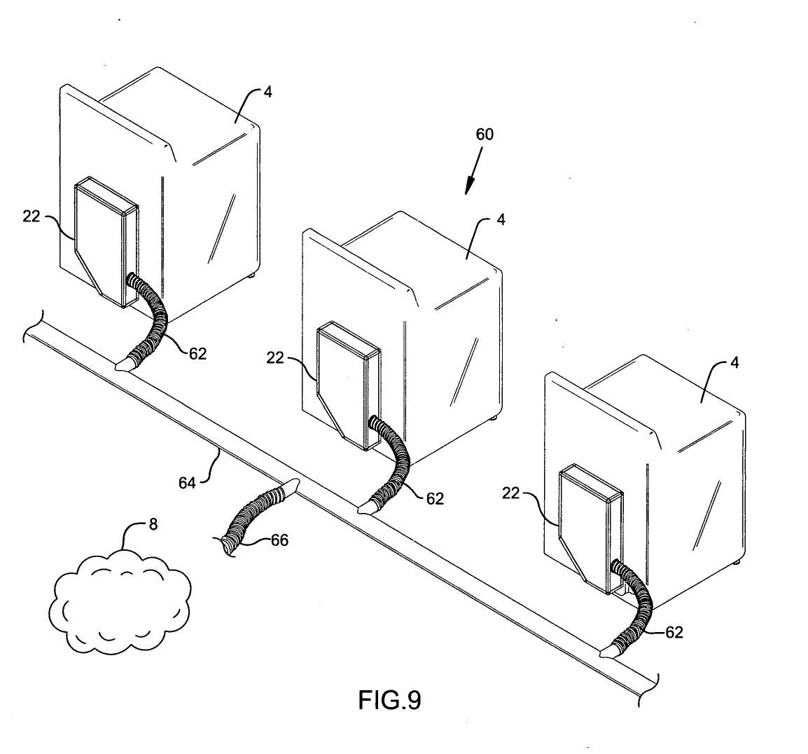

Referring to FIG. 8, another embodiment of an air intake system is shown generally at 50. This embodiment includes a conduit 56 coupled directly to an air intake of the dryer through a coupler 54. The air intake 52 of the dryer is coupled to the coupler 54 at a first end and ultimately to the heating element 58 at a second end. The heating element 58 shown is only one example of a conventional heating element, and alternative conventional designs include tunnel shaped heating elements in communication with the tumbling drum. In the embodiment shown, supply air from the outside environment enters through the conduit 56, passes through the coupler 54, and passes through the intake 52 to the heating element 58. As in the previous embodiment, the system 50 may further include a filter system or baffle position within the system as described in detail above.

Referring to FIG. 9, yet another embodiment of an air intake system for a plurality of interconnected dryers is shown generally at 60. In this embodiment, the system 60 functions to interconnect a plurality of dryers through the air intake system in order to simultaneously supply the dryers with an outside air supply. This embodiment finds particular application in apartment/condo buildings, institutions, laundromats, dormitories and any other facility including multiple dryers. The air intake system 60 includes enclosures 22 similar to those shown in FIGS. 3 and 4. The enclosures 22 are coupled with a main air supply line 64 through individual conduits 62. The main air supply line 64 may have any length for interconnecting and supplying air to any number of dryers 4. The main air supply line 64 is connected to the outside environment 8 through at least one conduit 66. Air is withdrawn through the conduit 66 and supplied to the individual dryers 4 through the main air supply line 64. As in the previous embodiment, the system 60 may further include one or more filter systems or baffles positioned anywhere within the system for performing filtering and baffling functions. The capacity of the filter or baffle system may be increased based on the combined capacity of the dryers. Although one example of an air intake system is shown, the air intake system may be substituted with the one similar that shown in FIG. 8 in which the enclosure is eliminated and direct coupling of the dryer air intakes with the supply line 64 occurs.

Although various embodiments have been described in detail, it is envisioned that alternative embodiments and modifications to the embodiments shown may be made without departing from the spirit and scope of the present invention. It is envisioned that all such embodiments be covered by the description provided herein. Furthermore, the foregoing description of the preferred embodiments of the invention and the best mode of practicing the invention are provided for the purpose of illustration only and not for the purpose of limitation.

What is claimed is:

1. An air intake system for supplying outdoor air to a clothes dryer, the air intake system comprising:
an enclosure positioned to substantially cover an air intake of a clothes dryer, the enclosure defining an air space therein for maintaining a volume of supply air and an open side positioned adjacent the air intake such that air is supplied to the air intake from the air space;
a conduit coupled with the enclosure and extending between the enclosure and the outdoor environment for supplying air to the air space from the outdoor environment;
wherein the enclosure substantially seals off the air intake from conditioned indoor air.

2. The air intake system according to claim 1, further comprising a baffle apparatus associated with the conduit for controlling airflow through the conduit.

3. The air intake system according to claim 1, further comprising a filter system associated with the conduit for filtering the airflow through the conduit.

4. The air intake system according to claim 3, wherein the filter system includes a filter box, a filter, and a selector valve for selecting between outdoor and indoor air sources.

5. The air intake system according to claim 3, wherein the filter system includes a blower motor for increasing airflow through the conduit.

6. The air intake system according to claim 1, wherein the enclosure further comprises a flap configured to be selectively opened and closed to expose the air space to conditioned indoor air.

7. The air intake system according to claim 1, further comprising a shared air supply line for simultaneously supplying outdoor air to a plurality of clothes dryers each of which include the enclosure coupled with the air supply line through the conduit.

8. The air intake system according to claim 1, wherein the end of the conduit positioned adjacent the outdoor environment is positioned apart from an exhaust vent of the dryer to prevent high-moisture content exhaust air from being withdrawn through the conduit.

9. The air intake system according to claim 1, wherein the enclosure is constructed from rigid material adapted to prevent the air space from collapsing under vacuum pressure from the dryer during operation.

10. The air intake system according to claim 1, wherein the dryer includes a plurality of air intakes and the enclosure is shaped to substantially cover the plurality of air intakes.

11. A clothes dryer, comprising:
a rotating drum for tumbling a load of clothes to be dried;
a heating element for heating dryer supply air;
a dryer air intake for supplying air to the heating element;
an exhaust vent for exhausting moist air to the outside environment; and
an air intake system associated with the air intake, the air intake system including a conduit defining first and second opposed ends, the first end being positioned adjacent the dryer air intake for effectively supplying outdoor air to the dryer air intake, and the second end being positioned adjacent an outdoor air source for withdrawing outdoor supply air.

12. The clothes dryer according to claim 11, further comprising a baffle apparatus positioned along the length of the conduit for controlling airflow through the conduit.

13. The clothes dryer according to claim 11, further comprising a filter system positioned along the length of the conduit for filtering the airflow through the conduit.

14. The clothes dryer according to claim 13, wherein the filter system includes a filter box, a filter, and a selector valve for selecting between outdoor and indoor air sources.

15. The clothes dryer according to claim 13, wherein the filter system includes a blower motor for increasing airflow through the conduit.

16. The clothes dryer according to claim 11, further comprising an enclosure coupled with the first end of the conduit for substantially covering the dryer air intake, the enclosure defining an air space therein for maintaining a volume of supply air and an open side positioned adjacent the dryer air intake such that air is supplied to the dryer air intake from the air space.

17. The clothes dryer according to claim 16, wherein the dryer includes a plurality of air intakes and the enclosure is shaped to substantially cover the plurality of air intakes.

18. The clothes dryer according to claim 11, further comprising a shared air supply line for simultaneously supplying outdoor air to a plurality of clothes dryers each including the conduit.

19. The clothes dryer according to claim 11, wherein the second end of the conduit is positioned apart from the exhaust vent to prevent high-moisture content exhaust air from being withdrawn through the conduit.

20. The clothes dryer according to claim 11, wherein the enclosure is constructed from rigid material adapted to prevent the air space from collapsing under vacuum pressure from the dryer.
